(19) United States
(12) Patent Application Publication
(10) Pub. No.: US 2026/0066273 A1
(43) Pub. Date: Mar. 5, 2026

(54) LITHIUM-ION-BATTERY ANODE MATERIALS CONTAINING LITHIUM VANADIUM OXIDE AND SILICON

(71) Applicant: Tyfast, San Diego, CA (US)

(72) Inventors: Haodong LIU, San Diego, CA (US); Ping LIU, San Diego, CA (US); Gerardo Jose LA O', San Mateo, CA (US); Kangwoon KIM, San Diego, CA (US)

(21) Appl. No.: 19/312,428

(22) Filed: Aug. 28, 2025

Related U.S. Application Data
(60) Provisional application No. 63/688,730, filed on Aug. 29, 2024.
(60) Provisional application No. 63/740,652, filed on Dec. 31, 2024.

(51) Int. Cl. H01M 4/36; H01M 4/38; H01M 4/48; H01M 4/485; H01M 4/587; H01M 10/0525

(52) U.S. Cl. CPC H01M 4/364; H01M 4/386; H01M 4/483; H01M 4/485; H01M 4/587; H01M 10/0525; H01M 2220/20; H01M 2220/30

(57) ABSTRACT

Some variations provide an anode material comprising: silicon monoxide in the form of first particles; and lithium vanadium oxide (LVO) with a composition given by LiₐV_{b}O_{c}, wherein a=0.1-10, b=1-3, c=1-9, wherein the LiₐV_{b}O_{c} is capable of being reversibly lithiated, wherein the LVO is present in the form of second particles that are physically mixed with the first particles. Other variations provide an anode material comprising: a Si/C composite in the form of first particles; lithium vanadium oxide in the form of second particles, wherein the first particles and the second particles are physically mixed together, wherein the Si/C composite is present in a Si/C concentration from about 1 wt % to about 99 wt %, and wherein the LVO is present in a LVO concentration from about 1 wt % to about 99 wt %. Examples are provided, demonstrating the utility of the disclosed technology.

### PRIORITY DATA

This non-provisional patent application claims priority to U.S. Provisional Patent App No. 63/688,730, filed on Aug. 29, 2024, and to U.S. Provisional Patent App No. 63/740,652, filed on Dec. 31, 2024, each of which is hereby incorporated by reference.

### FIELD

The present disclosure generally relates to lithium-ion batteries containing electrodes incorporating lithiated compounds.

### BACKGROUND

The push to electrify transportation will require the United States electric grid to double in capacity by 2050, assuming 186 million (two-thirds) of light-duty vehicles are converted to electrical energy rather than combustion engines. This shift will necessitate massive investments in new transmission lines and distribution systems that could reach over $1 trillion by 2050 when all 186 million light-duty electric vehicles (EVs) are in service. The electricity distribution system that connects to the EV charging station—including substations, circuits, switches, and transformers—will incur over 90% of this projected investment. Optimized EV charging and vehicle-to-grid integration can reduce the required distribution investments by ˜70% or $600 billion by minimizing congestion at the distribution level, allowing two-way energy transfers, storing energy closer to the load, and integrating widely distributed renewables.

Rechargeable lithium-ion (Li-ion) batteries that can be safely charged and discharged at high rates are desirable for electrified transportation, portable electronics, grid storage, and other important applications. Rechargeable Li-ion batteries have made mobile devices and personal computers an essential necessity in modern society. While important advancements in battery technology (e.g., energy density and structural stability) have continued, fast charging is a challenge that still requires significant advances for Li-ion batteries. Li-ion batteries may possess high energy density; however, the rate at which the battery can charge is limited by the battery anode.

Graphite has so far been the dominant anode material for rechargeable lithium-ion batteries due to its low cost, high reversibility, and working potential close to lithium metal. These attributes have led to batteries with high specific energy and long cycle life. The current commercial high-energy-density Li-ion batteries based on graphite anodes achieve a high energy density greater than 250 W·h/kg. However, these Li-ion batteries require several hours to charge. This is a significant problem, as can be attested by anyone with an electric vehicle held up at a charging station for hours—causing a tremendous waste of precious time.

Demand for ultrafast charging poses significant challenges for graphite. Under high charging rates, the anode potential in graphite can be driven to a value that causes lithium plating. Such lithium deposition leads to losses in battery lifetime and higher safety risk. Decreasing the battery charging time to minutes sacrifices energy and severely reduces cycle life for Li-ion batteries using graphite anodes.

The state-of-the-art commercially available anode for ultra-fast-charge Li-ion batteries is lithium titanate, Li₄Ti₅O₁₂ (LTO). Li₄Ti₅O₁₂ is a generally safe material that can charge in less than 10 minutes for many cycles, but its energy density is less than 90 W·h/kg. Li₄Ti₅O₁₂ has a potential of about 1.5 V vs. Li/Li⁺, which leads to a 2.5 V Li-ion battery when paired with a commercial 4 V cathode. The low energy density has limited the application of LTO primarily to buses and utility vehicles. The potentials for other intercalation anodes, such as LiV_{0.5}Ti_{0.5}S₂, are around 1 V, still far higher than desired. Alloy anodes (e.g., anodes using aluminum alloys) can have ideal potentials of 0.5 V and large capacities, but their cycling stabilities remain questionable even under normal operating conditions—let alone for extremely fast charging. None of the state-of-the-art systems can achieve both high energy density combined with high power density, thus defining a technology gap.

A severe challenge to widespread vehicle-to-grid adoption is the degradation of the battery as a result of high wear from extensive usage of the battery, in frequent discharging (while driving the EV) and charging (while connected to the grid for recharging). Similar challenges exist for heavy-duty vehicles, construction vehicles, two-wheel vehicles, boats, robotics, drones, electric vertical take-off and landing aircraft, and many other applications.

There remains a need for improved lithium-ion batteries, and improved anode materials for lithium-ion batteries.

### SUMMARY

Some variations of the invention provide an anode material comprising:
(a) silicon monoxide (SiO), wherein the SiO is present in the form of first particles; and
(b) lithium vanadium oxide (LVO) with a composition given by LiₐV_{b}O_{c}, wherein a=0.1-10, b=1-3, c=1-9, and a, b, and c are selected to charge-balance the LiₐV_{b}O_{c}, wherein the LiₐV_{b}O_{c} is capable of being reversibly lithiated, and wherein the LVO is present in the form of second particles,
wherein the first particles and the second particles are physically mixed together.

In some embodiments, the anode material is a lithium-ion-battery anode material.

In some embodiments, at least some of the LiₐV_{b}O_{c} has a disordered rocksalt structure in the Fm3̅m space group. In certain embodiments, a>3 in the LiₐV_{b}O_{c}.

In some embodiments, the SiO is present is a SiO concentration from about 1 wt % to about 99 wt % in the anode material, such as from about 5 wt % to about 50 wt %, or from about 10 wt % to about 30 wt %.

In some embodiments, the LVO is present in a LVO concentration from about 1 wt % to about 99 wt % in the anode material, such as from about 50 wt % to about 95 wt %, or from about 70 wt % to about 90 wt %.

In some embodiments, the anode material consists essentially of the SiO and the LVO. In other embodiments, the anode material further comprises elemental silicon (Si). In certain embodiments, the anode material further comprises silicon dioxide (SiO₂). In certain embodiments, the anode material further comprises elemental silicon (Si) and silicon dioxide (SiO₂).

In some embodiments, the anode material further comprises carbon. The carbon may be selected from the group consisting of amorphous carbon, carbon nanotubes, carbon black, vapor-growth carbon fiber, ultra-fine carbon, graphene, graphite, hard carbon, soft carbon, sp carbon, sp² carbon, sp³ carbon, and combinations thereof.

In some embodiments, the lithium vanadium oxide further contains a dopant M that is chemically or physically contained within the lithium vanadium oxide. The dopant M may be selected from the group consisting of Na, K, Be, Mg, Ca, Zn, Fe, Co, Ni, Cu, Ag, Sc, B, Y, Al, La, Si, Ge, Sn, Ti, Zr, Mn, P, Nb, Ta, Cr, Mo, W, Se, N, S, F, Cl, Br, I, and combinations thereof. The dopant M may be selected from monovalent, divalent, trivalent, tetravalent, pentavalent, or hexavalent dopants. The dopant M may be used to adjust lithiation, delithiation, or other kinetics; lithiation capacity; anode stability; lithiation-delithiation potential; anode material electronic conductivity; lithium-ion diffusivity in anode material crystal structures; thermal properties; and/or densities, for example.

Other variations provide an anode material comprising:
(a) silicon monoxide (SiO), wherein the SiO is present in the form of first particles;
(b) elemental silicon (Si), wherein the Si is present in the form of second particles;
(c) lithium vanadium oxide (LVO) with a composition given by LiₐV_{b}O_{c}, wherein a=0.1-10, b=1-3, c=1-9, and a, b, and c are selected to charge-balance the LiₐV_{b}O_{c}, wherein the LiₐV_{b}O_{c} is capable of being reversibly lithiated, and wherein the LVO is present in the form of third particles,
wherein the first particles, the second particles, and the third particles are physically mixed together.

In some embodiments, the anode material is a lithium-ion-battery anode material.

In some embodiments, at least some of the LiₐV_{b}O_{c} has a disordered rocksalt structure in the Fm3̅m space group. In certain embodiments, a>3 in the LiₐV_{b}O_{c}.

In some embodiments, the SiO and the Si are collectively present in a Si+SiO concentration from about 1 wt % to about 99 wt % in the anode. In certain embodiments, the Si+SiO concentration is from about 5 wt % to about 50 wt %, or from about 10 wt % to about 30 wt %.

In some embodiments, the LVO is present in a LVO concentration from about 1 wt % to about 99 wt % in the anode material, such as from about 50 wt % to about 95 wt %, or from about 60 wt % to about 90 wt %.

In some embodiments, the anode material consists essentially of the SiO, the Si, and the LVO. The anode material may further comprise silicon dioxide (SiO₂).

In some embodiments, the anode material further comprises carbon, such as carbon selected from the group consisting of amorphous carbon, carbon nanotubes, carbon black, vapor-growth carbon fiber, ultra-fine carbon, graphene, graphite, hard carbon, soft carbon, sp carbon, sp² carbon, sp³ carbon, and combinations thereof.

In some embodiments, the lithium vanadium oxide further contains a dopant M that is chemically or physically contained within the lithium vanadium oxide. The dopant M may be selected from the group consisting of Na, K, Be, Mg, Ca, Zn, Fe, Co, Ni, Cu, Ag, Sc, B, Y, Al, La, Si, Ge, Sn, Ti, Zr, Mn, P, Nb, Ta, Cr, Mo, W, Se, N, S, F, Cl, Br, I, and combinations thereof. The dopant M may be selected from monovalent, divalent, trivalent, tetravalent, pentavalent, or hexavalent dopants. The dopant M may be used to adjust lithiation, delithiation, or other kinetics; lithiation capacity; anode stability; lithiation-delithiation potential; anode material electronic conductivity; lithium-ion diffusivity in anode material crystal structures; thermal properties; and/or densities, for example.

Other variations provide an anode material comprising:
(a) a Si/C composite containing silicon (Si) and carbon (C), wherein the Si/C composite is present in the form of first particles;
(b) lithium vanadium oxide (LVO) with a composition given by LiₐV_{b}O_{c}, wherein a=0.1-10, b=1-3, c=1-9, and a, b, and c are selected to charge-balance the LiₐV_{b}O_{c}, wherein the LiₐV_{b}O_{c} is capable of being reversibly lithiated, and wherein the LVO is present in the form of second particles,
wherein the first particles and the second particles are physically mixed together,
wherein the Si/C composite is present in a Si/C concentration from about 1 wt % to about 99 wt % in the anode material, and
wherein the LVO is present in a LVO concentration from about 1 wt % to about 99 wt % in the anode material.

In some embodiments, the anode material is a lithium-ion-battery anode material.

In some embodiments, at least some of the LiₐV_{b}O_{c} has a disordered rocksalt structure in the Fm3̅m space group. Optionally, a>3 in the LiₐV_{b}O_{c}.

In some embodiments, the Si/C concentration is from about 10 wt % to about 50 wt % (e.g., 20-40 wt %) in the anode material. The LVO concentration may be from about 50 wt % to about 90 wt % (e.g., 60-80 wt %) in the anode material.

In some embodiments, the Si/C composite contains from about 20 wt % to about 60 wt % of carbon, and from about 40 wt % to about 80 wt % of silicon. In certain embodiments, the Si/C composite contains from about 30 wt % to about 50 wt % of carbon, and from about 50 wt % to about 70 wt % of silicon. Wide ranges of carbon (1-99 wt %) and silicon (99-1 wt %) may be used for the Si/C composite.

In some embodiments using Si/C composites, the anode material further comprises silicon monoxide (SiO). The SiO may be contained within the Si/C particles, within the LVO particles, as separate particles, or a combination thereof.

In some embodiments, the lithium vanadium oxide further contains a dopant M that is chemically or physically contained within the lithium vanadium oxide. The dopant M may be selected from the group consisting of Na, K, Be, Mg, Ca, Zn, Fe, Co, Ni, Cu, Ag, Sc, B, Y, Al, La, Si, Ge, Sn, Ti, Zr, Mn, P, Nb, Ta, Cr, Mo, W, Se, N, S, F, Cl, Br, I, and combinations thereof. The dopant M may be selected from monovalent, divalent, trivalent, tetravalent, pentavalent, or hexavalent dopants. The dopant M may be used to adjust lithiation, delithiation, or other kinetics; lithiation capacity; anode stability; lithiation-delithiation potential; anode material electronic conductivity; lithium-ion diffusivity in anode material crystal structures; thermal properties; and/or densities, for example.

In some variations, a cell contains the disclosed anode material. The cell comprises an anode, a cathode, and a lithium-ion conductor interposed between the anode and the cathode, wherein the anode contains the anode material.

In some cell embodiments, the cathode contains a cathode material selected from the group consisting of sulfur, sulfurized polyacrylonitrile, ferric fluoride, metal fluoride, metal sulfide, lithium nickel manganese cobalt oxide (LiNiₓCo_{y}Mn_{z}O₂ (x+y+z=1)), lithium nickel manganese oxide (LiMnₓNi_{y}O₂ (x+y=1)), lithium nickel cobalt oxide (LiNiₓCo_{y}O₂ (x+y=1)), lithium nickel cobalt aluminum oxide (LiNiₓCo_{y}Al_{z}O₂ (x+y+z=1)), lithium cobalt oxide (LiCoO₂), lithium nickel manganese spinel oxide ((LiMnₓNi_{y}O₄ (x+y=2))), lithium manganese spinel oxide (LiMn₂O₄), lithium iron phosphate (LiFePO₄), lithium iron manganese phosphate (LiFeₓMn_{y}PO₄ (x+y=1)), Li₂MnO₃, aLiNiₓCo_{y}Mn_{z}O₂·(1-a)Li₂MnO₃ (0<a<1 and x+y+z=1), LiF, Li₂S, Li₂O, Li₂O₂, and combinations thereof.

In some cell embodiments, the lithium-ion conductor is a liquid lithium-ion conductor. The lithium-ion conductor may be a solid lithium-ion conductor or a polymer gel lithium-ion conductor, for example.

In some cell embodiments, the cell is capable of charging from 0% state of charge to 80% state of charge in about 15 minutes or less when charged at a rate of 5C and at a temperature of 25° C. In some cell embodiments, the cell is capable of charging from 0% state of charge to 80% state of charge in about 10 minutes or less when charged at a rate of 10C and at a temperature of 25° C. In some cell embodiments, the cell is capable of charging from 0% state of charge to 80% state of charge in about 5 minutes or less when charged at a rate of 15C or 20C and at a temperature of 25° C.

In some cell embodiments, the anode delivers at least 500 mA·h/g at a temperature of 25° C. when discharged at a rate of C/3. In certain embodiments, the anode delivers at least 600 mA·h/g at a temperature of 25° C. when discharged at a rate of C/3. In some cell embodiments, the anode delivers at least 400 mA·h/g at a temperature of −20° C. when discharged at a rate of C/3. In certain embodiments, the anode of cell delivers at least 500 mA·h/g at a temperature of −20° C. when discharged at a rate of C/3.

In some cell embodiments, the cell is characterized by a capacity loss of less than 0.8% per degree Celsius over the temperature range from 25° C. to −20° C. In certain embodiments, the cell is characterized by a capacity loss of less than 0.4% per degree Celsius over the temperature range from 25° C. to −20° C.

The cell may be contained in a module or pack. The cell may be contained in an electric device. The cell may be contained in an electric vehicle, such as (but not limited to) an electric vehicle selected from electric cars, electric trucks, electric motorcycles, electric buses, electric utility vehicles, electric airplanes, or electric locomotives.

### BRIEF DESCRIPTION OF THE FIGURES

FIG. 1 left graph shows the voltage profile of Tyfast LVO-SiO anode under 0.5C, 5C, 10C, and 20C constant current lithiation with constant voltage step current cut at 0.33C and 0.33C delithiation in the coin cell with Li counter electrode, in Example 1. FIG. 1, right graph demonstrates 5.1 min charge time from 0 to 80% SOC for a 20C rate, in Example 1.

FIG. 2, left graph shows the voltage profile of Tyfast LVO-Si/C anode under 0.5C, 5C, 10C, and 20C constant current lithiation with constant voltage step current cut at 0.33C and 0.33C delithiation in the coin cell with Li counter electrode, in Example 2. FIG. 2, right graph demonstrates 6.5 min charge time from 0 to 80% SOC at a 20C rate, in Example 2.

FIG. 3 shows the cycling performance of Tyfast LVO-Si/C and LVO-SiO anode under 15C constant current lithiation with constant voltage step current cut at 0.33C and 0.33C delithiation in the coin cell with Li counter electrode, in Example 3.

FIG. 4, left graph shows the voltage profile of Tyfast LVO-SiO∥NMC811 full pouch cell under 0.5C, 5C, 10C, and 20C constant current charge with constant voltage step current cut at 0.33C and 0.33C discharge, in Example 4. FIG. 4, right graph demonstrates 4.7 min charge time from 0 to 80% SOC, in Example 4.

FIG. 5 shows the cycling performance of Tyfast LVO-SiO∥NMC811 full pouch cell under 15C constant current charge with constant voltage step current cut at 0.33C and 0.33C discharge, in Example 5.

FIG. 6, left graph shows the voltage profile of Tyfast LVO-Si/C∥NMC811 full pouch cell under 0.5C, 5C, 10C, and 20C constant current charge with constant voltage step current cut at 0.33C and 0.33C discharge, in Example 6. FIG. 6, right graph demonstrates 5.0 min charge time from 0 to 80% SOC, in Example 6.

FIG. 7 shows the cycling performance of Tyfast LVO-Si/C∥NMC811 full pouch cell under 15C constant current charge with constant voltage step current cut at 0.33C and 0.33C discharge, in Example 7.

FIG. 8 shows the voltage profiles of Tyfast LVO-Si/C∥NMC811 full pouch cell under 0.5C constant current charge with constant voltage step current cut at 0.33C charge and 0.33C discharge, at a temperature of 25° C. and −20° C., in Example 8.

FIG. 9 shows the voltage profile of Tyfast LVO-Si/C anode under 0.5C, 5C, 10C, and 20C constant current lithiation with constant voltage step current cut at 0.33C and 0.33C delithiation in a coin cell with Li counter electrode, in Example 9.

FIG. 10 FIG. 10 shows cycling performance of Tyfast LVO-Si/C∥NMC811 full pouch cell, with three cycles at 3C constant current charge with constant voltage step current cut at 0.33C, followed by one cycle at 1° C. constant current charge with constant voltage step current cut at 0.33C and C/3 discharge, using an 80% SOC swing, in Example 10.

### DETAILED DESCRIPTION OF EMBODIMENTS

The principles, compositions, systems, and methods of the present disclosure will be described in detail by reference to various non-limiting embodiments of the technology.

This description will enable one skilled in the art to make and use the technology, and it describes several embodiments, adaptations, variations, alternatives, and uses of the technology. These and other embodiments, features, and advantages of the present technology will become more apparent to those skilled in the art when taken with reference to the following detailed description in conjunction with the accompanying drawings.

Unless defined otherwise, all technical and scientific terms used herein have the same meaning as is commonly understood by one of ordinary skill in the art to which this technology belongs.

Unless otherwise indicated, all numbers expressing conditions, concentrations, dimensions, and so forth used in the specification and claims are to be understood as being modified in all instances by the term “about.” Accordingly, unless indicated to the contrary, the numerical parameters set forth in the following specification and attached claims are approximations that may vary depending at least upon a specific analytical technique.

The term “comprising,” which is synonymous with “including,” “containing,” or “characterized by” is inclusive or open-ended and does not exclude additional, unrecited elements or method steps. “Comprising” is a term of art used in claim language which means that the named claim elements are essential, but other claim elements may be added and still form a construct within the scope of the claim.

As used herein, the phrase “consisting of” excludes any element, step, or ingredient not specified in the claim. When the phrase “consists of” (or variations thereof) appears in a clause of the body of a claim, rather than immediately following the preamble, it limits only the element set forth in that clause; other elements are not excluded from the claim as a whole. As used herein, the phrase “consisting essentially of” limits the scope of a claim to the specified elements or method steps, plus those that do not materially affect the basis and novel characteristic(s) of the claimed subject matter.

With respect to the terms “comprising” (synonymously, “including”), “consisting of,” and “consisting essentially of,” where one of these three terms is used herein, the presently disclosed and claimed subject matter may include the use of either of the other two terms, except when used in Markush groups. Thus in some embodiments not otherwise explicitly recited, any instance of “comprising” may be replaced by “consisting of” or, alternatively, by “consisting essentially of.” The term “including” should be read as meaning “including, without limitation” or the like; the term “example” is used to provide exemplary instances of the item in discussion, not an exhaustive or limiting list thereof.

Adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this patent application refers to technologies that would be apparent or known to one of ordinary skill in the art, such technologies encompass those apparent or known to the skilled artisan now or at any time in the future.

In this specification, hypotheses and theories are disclosed, it being understood that the present invention is not limited to the proposed hypotheses and theories.

In this specification, with respect to a concentration of a component within a composition, a percentage is in reference to weight percent (wt %), unless indicated otherwise.

As used in this specification and the appended claims, the singular forms “a,” “an,” and “the” include plural referents unless the context clearly indicates otherwise. The terms “a” or “an” should be read as meaning “at least one,” “one or more” or the like. The presence of broadening words and phrases such as “one or more,” “at least,” “but not limited to” or other like phrases in some instances shall not be read to mean that the narrower case is intended or required in instances where such broadening phrases may be absent.

Some embodiments of the disclosure are premised on the discovery of a blend electrode that combines lithium vanadium oxide and silicon materials with complementary properties, significantly enhancing calendar life. For instance, blending materials with high stability and slow degradation rates with those offering high energy density can balance performance and longevity. This approach mitigates stress on the electrode structure, reduces degradation pathways, and improves the overall chemical stability of the battery, extending its operational lifespan.

Some variations provide an anode material comprising:
(a) silicon monoxide (SiO), wherein the SiO is present in the form of first particles; and
(b) lithium vanadium oxide (LVO) with a composition given by LiₐV_{b}O_{c}, wherein a=0.1-10, b=1-3, c=1-9, and a, b, and c are selected to charge-balance the LiₐV_{b}O_{c}, wherein the LiₐV_{b}O_{c} is capable of being reversibly lithiated, and wherein the LVO is present in the form of second particles,
wherein the first particles and the second particles are physically mixed together.

In preferred embodiments, the anode material is a lithium-ion-battery anode material.

In preferred embodiments, at least some of the LiₐV_{b}O_{c} has a disordered rocksalt structure in the Fm3̅m space group. In certain embodiments, a>3 in the LiₐV_{b}O_{c}.

In some embodiments, the SiO is present is a SiO concentration from about 1 wt % to about 99 wt % in the anode material. In certain embodiments, the SiO concentration is from about 5 wt % to about 50 wt %. In certain embodiments, the SiO concentration is from about 10 wt % to about 30 wt %.

In some embodiments, the LVO is present in a LVO concentration from about 1 wt % to about 99 wt % in the anode material. In certain embodiments, the LVO concentration is from about 50 wt % to about 95 wt %. In certain embodiments, the LVO concentration is from about 60 wt % to about 90 wt %. In certain embodiments, the LVO concentration is from about 70 wt % to about 90 wt %.

In some embodiments, the anode material consists essentially of the SiO and the LVO. In certain embodiments, the anode material consists of the SiO and the LVO.

In some embodiments, the anode material further comprises elemental silicon (Si). In some embodiments, the anode material further comprises silicon dioxide (SiO₂). In certain embodiments, the anode material further comprises elemental silicon (Si) and silicon dioxide (SiO₂).

In some embodiments, the anode material further comprises carbon. The carbon may be selected from the group consisting of amorphous carbon, carbon nanotubes, carbon black, vapor-growth carbon fiber, ultra-fine carbon, graphene, graphite, hard carbon, soft carbon, sp carbon, sp² carbon, sp³ carbon, and combinations thereof, for example.

Some variations employ a mixture of Si and SiO to provide an anode material comprising:
(a) silicon monoxide (SiO), wherein the SiO is present in the form of first particles;
(b) elemental silicon (Si), wherein the Si is present in the form of second particles;
(c) lithium vanadium oxide (LVO) with a composition given by LiₐV_{b}O_{c}, wherein a=0.1-10, b=1-3, c=1-9, and a, b, and c are selected to charge-balance the LiₐV_{b}O_{c}, wherein the LiₐV_{b}O_{c} is capable of being reversibly lithiated, and wherein the LVO is present in the form of third particles,
wherein the first particles, the second particles, and the third particles are physically mixed together.

In preferred embodiments employing a mixture of Si and SiO, the anode material is a lithium-ion-battery anode material.

In preferred embodiments employing a mixture of Si and SiO, at least some of the LiₐV_{b}O_{c} has a disordered rocksalt structure in the Fm3̅m space group. In certain embodiments, a>3 in the LiₐV_{b}O_{c}.

In some embodiments employing a mixture of Si and SiO, the SiO is present is a SiO concentration from about 1 wt % to about 99 wt % in the anode material. In certain embodiments, the SiO concentration is from about 5 wt % to about 50 wt %. In certain embodiments, the SiO concentration is from about 10 wt % to about 30 wt %.

In some embodiments employing a mixture of Si and SiO, the sum of silicon and silicon monoxide is a Si+SiO concentration from about 1 wt % to about 99 wt % in the anode material. In certain embodiments, the Si+SiO concentration is from about 5 wt % to about 50 wt %. In certain embodiments, the Si+SiO concentration is from about 10 wt % to about 30 wt %.

In some embodiments employing a mixture of Si and SiO, the LVO is present in a LVO concentration from about 1 wt % to about 99 wt % in the anode material. In certain embodiments, the LVO concentration is from about 50 wt % to about 95 wt %. In certain embodiments, the LVO concentration is from about 60 wt % to about 90 wt %. In certain embodiments, the LVO concentration is from about 70 wt % to about 90 wt %.

In some embodiments employing a mixture of Si and SiO, the anode material consists essentially of the Si, the SiO, and the LVO. In certain embodiments, the anode material consists of the Si, the SiO, and the LVO.

In some embodiments employing a mixture of Si and SiO, the anode material further comprises silicon dioxide (SiO₂).

In some embodiments employing a mixture of Si and SiO, the anode material further comprises carbon. The carbon may be selected from the group consisting of amorphous carbon, carbon nanotubes, carbon black, vapor-growth carbon fiber, ultra-fine carbon, graphene, graphite, hard carbon, soft carbon, sp carbon, sp² carbon, sp³ carbon, and combinations thereof, for example.

In some embodiments employing SiO, the lithium vanadium oxide further contains a dopant M that is chemically or physically contained within the lithium vanadium oxide such that its composition is given by LiₐV_{b}O_{c}M_{d}, wherein a=0.001-10, b=1-3, c=1-9, and d=0.001-3, wherein a, b, c, and d are selected to charge-balance the LiₐV_{b}O_{c}M_{d}, and wherein the LiₐV_{b}O_{c}M_{d} is capable of being reversibly lithiated. The formula LiₐV_{b}O_{c}M_{d} is a stoichiometric convenience and does not necessarily mean that the dopant M is chemically bonded with any other species present.

The dopant M may be selected from the group consisting of Na, K, Be, Mg, Ca, Zn, Fe, Co, Ni, Cu, Ag, Sc, B, Y, Al, La, Si, Ge, Sn, Ti, Zr, Mn, P, Nb, Ta, Cr, Mo, W, Se, N, S, F, Cl, Br, I, and combinations thereof, for example. The dopants may include one or more monovalent, divalent, trivalent, tetravalent, pentavalent, or hexavalent dopants. Multiple dopants may be present in LiₐV_{b}O_{c}M_{d}, in which case each dopant in the empirical formula may have d=0.1-3.

Dopants may be used to modify the properties of the lithium vanadium oxide. For example, dopants may be used to adjust lithiation, delithiation, or other kinetics; lithiation capacity; anode stability; lithiation-delithiation potential; anode material electronic conductivity; lithium-ion diffusivity in anode material crystal structures; thermal properties; densities; and/or other factors.

The doped composition may have a disordered rocksalt structure. The disordered rocksalt crystal lattice may or may not incorporate the dopant elements. That is, when there is a dopant M, in some embodiments, the disordered rocksalt crystal structure of LiₐV_{b}O_{c}M_{d} is a crystal lattice containing a disordered arrangement of Li atoms, V atoms, and M atoms on the cation lattice site. Alternatively, or additionally, the dopant M may be in a different position than within the cation lattice of the disordered rocksalt crystal structure, such as randomly placed, or in a different crystalline lattice governing the relationship of M with other atoms, potentially superimposed on the disordered rocksalt crystal structure. In certain embodiments, the presence of a dopant M reduces the optimal amount of vanadium (the value of b) in the disordered rocksalt anode material. In certain embodiments, dopant M atoms replace lithium Li atoms. In other certain embodiments, the presence of a non-metal dopant M (e.g., M=N, S, F, Cl, Br, or I) reduces the optimal amount of oxygen (the value of c) in the disordered rocksalt anode material.

In preferred embodiments using a dopant, at least some of the LiₐV_{b}O_{c}M_{d} has a disordered rocksalt structure in the Fm3̅m space group. About 0.01 wt % to 100 wt % of the LiₐV_{b}O_{c}M_{d} may have a disordered rocksalt structure in the Fm3̅m space group.

The LiₐV_{b}O_{c}M_{d} (doped anode material) may have a density of about 1.5 g/cm³ to about 5.5 g/cm³. Preferably, at least 50 wt % or at least 90 wt % of the LiₐV_{b}O_{c}M_{d} has a disordered rocksalt structure in the Fm3̅m space group. In various embodiments, at least 50 wt %, 60 wt %, 70 wt %, 80 wt %, 90 wt %, 95 wt %, or 99 wt % (such as 100 wt %) of the LiₐV_{b}O_{c}M_{d} has a disordered rocksalt structure in the Fm3̅m space group.

Other variations provide an anode material comprising:
(a) a Si/C composite containing silicon (Si) and carbon (C), wherein the Si/C composite is present in the form of first particles;
(b) lithium vanadium oxide (LVO) with a composition given by LiₐV_{b}O_{c}, wherein a=0.1-10, b=1-3, c=1-9, and a, b, and c are selected to charge-balance the LiₐV_{b}O_{c}, wherein the LiₐV_{b}O_{c} is capable of being reversibly lithiated, and wherein the LVO is present in the form of second particles,
wherein the first particles and the second particles are physically mixed together,
wherein the Si/C composite is present in a Si/C concentration from about 1 wt % to about 99 wt % in the anode material, and
wherein the LVO is present in a LVO concentration from about 1 wt % to about 99 wt % in the anode material.

In preferred embodiments, the anode material is a lithium-ion-battery anode material.

In preferred embodiments, at least some of the LiₐV_{b}O_{c} has a disordered rocksalt structure in the Fm3̅m space group. In certain embodiments, a>3 in the LiₐV_{b}O_{c}.

In some embodiments, the Si/C concentration is from about 10 wt % to about 50 wt %. In certain embodiments, the Si/C concentration is from about 10 wt % to about 40 wt %, such as about 20 wt % (Example 2) or about 35 wt % (Example 9). In various embodiments, the Si/C concentration in the anode material is about, at least about, or at most about 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 45, 50, 55, 60, 65, 70, 75, 80, 85, 90, 95, or 99 wt %, including any intervening range.

In some embodiments, the LVO concentration is from about 50 wt % to about 90 wt %. In certain embodiments, the LVO concentration is from about 60 wt % to about 90 wt %, such as about 80 wt % (Example 2) or about 65 wt % (Example 9). In various embodiments, the LVO concentration in the anode material is about, at least about, or at most about 1, 2, 5, 10, 15, 20, 25, 30, 35, 40, 45, 50, 55, 60, 65, 70, 75, 80, 85, 90, 95, or 99 wt %, including any intervening range.

In some embodiments, the Si/C composite contains from about 1 wt % to about 99 wt % of carbon, such as from about 20 wt % to about 60 wt % of carbon, and from about 99 wt % to about 1 wt % of silicon, such as from about 40 wt % to about 80 wt % of silicon. In certain embodiments, the Si/C composite contains from about 30 wt % to about 50 wt % of carbon, and from about 50 wt % to about 70 wt % of silicon. In various embodiments, the carbon concentration in the Si/C composite is about, at least about, or at most about 1, 2, 5, 10, 15, 20, 25, 30, 35, 40, 45, 50, 55, 60, 65, 70, 75, 80, 85, 90, 95, or 99 wt %, including any intervening range. In various embodiments, the silicon concentration in the Si/C composite is about, at least about, or at most about 1, 2, 5, 10, 15, 20, 25, 30, 35, 40, 45, 50, 55, 60, 65, 70, 75, 80, 85, 90, 95, or 99 wt %, including any intervening range.

In some embodiments employing a Si/C composite, the lithium vanadium oxide further contains a dopant M that is chemically or physically contained within the lithium vanadium oxide such that its composition is given by LiₐV_{b}O_{c}M_{d}, wherein a=0.001-10, b=1-3, c=1-9, and d=0.001-3, wherein a, b, c, and d are selected to charge-balance the LiₐV_{b}O_{c}M_{d}, and wherein the LiₐV_{b}O_{c}M_{d} is capable of being reversibly lithiated. The formula LiₐV_{b}O_{c}M_{d} is a stoichiometric convenience and does not necessarily mean that the dopant M is chemically bonded with any other species present.

The dopant M may be selected from the group consisting of Na, K, Be, Mg, Ca, Zn, Fe, Co, Ni, Cu, Ag, Sc, B, Y, Al, La, Si, Ge, Sn, Ti, Zr, Mn, P, Nb, Ta, Cr, Mo, W, Se, N, S, F, Cl, Br, I, and combinations thereof, for example. The dopants may include one or more monovalent, divalent, trivalent, tetravalent, pentavalent, or hexavalent dopants. Multiple dopants may be present in LiₐV_{b}O_{c}M_{d}, in which case each dopant in the empirical formula may have d=0.1-3.

Dopants may be used to modify the properties of the lithium vanadium oxide. For example, dopants may be used to adjust lithiation, delithiation, or other kinetics; lithiation capacity; anode stability; lithiation-delithiation potential; anode material electronic conductivity; lithium-ion diffusivity in anode material crystal structures; thermal properties; densities; and/or other factors.

The doped composition may have a disordered rocksalt structure. The disordered rocksalt crystal lattice may or may not incorporate the dopant elements. That is, when there is a dopant M, in some embodiments, the disordered rocksalt crystal structure of LiₐV_{b}O_{c}M_{d} is a crystal lattice containing a disordered arrangement of Li atoms, V atoms, and M atoms on the cation lattice site. Alternatively, or additionally, the dopant M may be in a different position than within the cation lattice of the disordered rocksalt crystal structure, such as randomly placed, or in a different crystalline lattice governing the relationship of M with other atoms, potentially superimposed on the disordered rocksalt crystal structure. In certain embodiments, the presence of a dopant M reduces the optimal amount of vanadium (the value of b) in the disordered rocksalt anode material. In certain embodiments, dopant M atoms replace lithium Li atoms. In other certain embodiments, the presence of a non-metal dopant M (e.g., M=N, S, F, Cl, Br, or I) reduces the optimal amount of oxygen (the value of c) in the disordered rocksalt anode material.

In preferred embodiments using a dopant, at least some of the LiₐV_{b}O_{c}M_{d} has a disordered rocksalt structure in the Fm3̅m space group. About 0.01 wt % to 100 wt % of the LiₐV_{b}O_{c}M_{d} may have a disordered rocksalt structure in the Fm3̅m space group.

The LiₐV_{b}O_{c}M_{d} (doped anode material) may have a density of about 1.5 g/cm³ to about 5.5 g/cm³. Preferably, at least 50 wt % or at least 90 wt % of the LiₐV_{b}O_{c}M_{d} has a disordered rocksalt structure in the Fm3̅m space group. In various embodiments, at least 50 wt %, 60 wt %, 70 wt %, 80 wt %, 90 wt %, 95 wt %, or 99 wt % (such as 100 wt %) of the LiₐV_{b}O_{c}M_{d} has a disordered rocksalt structure in the Fm3̅m space group.

The anode-material particles may have various sizes and shapes. The first particles, second particles, and (when applicable) third particles may all have the same or different sizes and/or shapes. All references below to anode-material particles will be understood as referring in some embodiments individually, or collectively, to LVO particles, SiO particles, Si/C particles, or Si particles.

In some embodiments, the anode-material particles have a shape selected from the group consisting of spherical, columnar, cubic, irregular, and combinations thereof. The anode-material particles may have an average effective diameter selected from about 0.01 microns to about 100 microns, for example. In various embodiments, the average effective diameter of the anode-material particles is about, at least about, or at most about 0.01, 0.05, 0.1, 0.2, 0.3, 0.4, 0.5, 1, 1.5, 2, 2.5, 3, 4, 5, 10, 15, 20, 25, 30, 40, 50, 60, 70, 80, 90, or 100 microns, including any intervening ranges. The anode-material particles may have a unimodal or a multimodal size distribution.

Particle sizes may be measured by a variety of techniques, including dynamic light scattering, laser diffraction, or image analysis, for example. Dynamic light scattering is a non-invasive, well-established technique for measuring the size and size distribution of particles typically in the submicron region, and with the latest technology down to 1 nanometer. Laser diffraction is a widely used particle-sizing technique for materials ranging from hundreds of nanometers up to several millimeters in size. Exemplary dynamic light scattering instruments and laser diffraction instruments for measuring particle sizes are available from Malvern Instruments Ltd., Worcestershire, UK. Image analysis to estimate particle sizes and distributions can be done directly on photomicrographs, scanning electron micrographs, or other images.

For use, the anode material is placed into an anode, which may be configured in various ways.

In some embodiments, the anode has an anode material loading selected from about 20 wt % to about 100 wt %, such as about 20 wt %, 30 wt %, 40 wt %, 50 wt %, 60 wt %, 70 wt %, 80 wt %, 90 wt %, or 100 wt %, including any intervening ranges.

In some embodiments, the anode has an anode material areal loading selected from about 0.2 mg/cm² to about 50 mg/cm² on at least one side of the anode, such as about 0.2, 0.5, 1, 2, 5, 10, 15, 20, 25, 30, 35, 40, 45, or 50 mg/cm², including any intervening ranges, on at least one side of the anode (e.g., on both sides of the anode).

In some embodiments, the anode has an anode material areal capacity selected from about 0.05 mA·h/cm² to about 10 mA·h/cm² on at least one side of the anode, such as about 0.05, 0.1, 0.2, 0.5, 1, 2, 3, 4, 5, 6, 7, 8, 9, or 10 mA·h/cm², including any intervening ranges, on at least one side of the anode (e.g., on both sides of the anode).

In some embodiments, the anode has a capacity ranging from about 50 mA·h/g to about 2000 mA·h/g, such as about 50, 100, 150, 200, 250, 300, 350, 400, 450, 500, 600, 700, 800, 900, 1000, 1100, 1200, 1300, 1400, 1500, 1600, 1700, 1800, 1900, or 2000 mA·h/g, including any intervening ranges.

In some embodiments, the anode has a negative to positive electrode ratio (N/P ratio) ranging from about 0.5 to about 2, such as about 0.5, 0.6, 0.7, 0.8, 0.9, 1.0, 1.1, 1.2, 1.3, 1.4, 1.5, 1.6, 1.7, 1.8, 1.9, or 2.0, including any intervening ranges.

In some embodiments, the anode has a volumetric anode porosity selected from about 5% to about 80%. In various embodiments, the anode has a volumetric anode porosity of about, at least about, or at most about 5%, 10%, 15%, 20%, 25%, 30%, 40%, 50%, 60%, 70%, or 80%, including any intervening ranges.

In some embodiments, the anode has an average anode thickness from about 100 nanometers to about 500 microns. In various embodiments, the anode has an average anode thickness of about, at least about, or at most about 100 nm, 200 nm, 300 nm, 400 nm, 500 nm, 1 μm, 2 μm, 5 μm, 10 μm, 15 μm, 20 μm, 25 μm, 30 μm, 40 μm, 50 μm, 60 μm, 70 μm, 80 μm, 90 μm, 100 μm, 200 μm, 300 μm, 400 μm, or 500 μm, including any intervening ranges.

A copper foil, or other metal foil, may be used as a substrate upon which to place the anode material. In some embodiments, the copper foil thickness may range from about 1 μm to about 100 μm, such as about 1, 5, 10, 20, 30, 40, or 50 μm, including any intervening ranges. In some embodiments, the anode press density may range from about 0.3 g/cm³ to about 5 g/cm³, such as about 0.3, 0.4, 0.5, 1, 1.5, 2, 2.5, 3, 3.5, 4, 4.5, or 5 g/cm³, including any intervening ranges.

When the anode material is disposed on a substrate, typically the anode material is disposed on both sides of a substrate layer. This is referred to as a double layer. Within a cell, the number of double layers may vary widely, such as from 1 to about 50, e.g. about 1, 2, 3, 4, 5, 10, 15, 20, 25, 30, 35, 40, 45, 50, or more.

In some embodiments, the anode further contains one or more binders. Binders may hold active anode material together as well as place the active anode material in contact with the anode substrate (e.g., copper foil). The binders may also help keep conductive carbon additives in place against the active material.

The binders may be aqueous-based binders selected from the group consisting of carboxymethyl cellulose, styrene-butadiene rubber, styrene-butadiene copolymer, polyacrylic acid, lithium-substituted polyacrylic acid, and combinations thereof, for example. Alternatively, or additionally, the binders may be non-aqueous-based binders selected from the group consisting of polyvinylidene fluoride, poly(vinylidenefluoride-co-hexafluoropropylene), polytetrafluoroethylene, and combinations thereof, for example.

The binders may range in concentration from about 0 wt % to about 50 wt % of the anode, for example. In various embodiments, the binders collectively have a total concentration of about, at least about, or at most about 0 wt %, 0.25 wt %, 0.5 wt %, 1 wt %, 2 wt %, 5 wt %, 10 wt %, 15 wt %, 20 wt %, 25 wt %, 30 wt %, 40 wt %, 50 wt %, 60 wt %, 70 wt %, or 80 wt %, including any intervening ranges.

Some variations provide a cell utilizing the anode material as disclosed, which includes LVO and one or more of Si/C, SiO, and Si. A “cell” is an electrochemical cell that is capable of either generating electrical energy from chemical reactions or using electrical energy to cause chemical reactions. In this disclosure, the cell comprises an anode, a cathode, and a lithium-ion conductor interposed between the anode and the cathode, and wherein the anode contains the anode material.

The cell may comprise a cathode, an electrolyte layer, and a packet foil surrounding the anode, the electrolyte layer, and the cathode, wherein the electrolyte layer electrically separates the anode from the cathode. The anode composite may be disposed on a first substrate (e.g., copper foil) to form an anode, and the cathode composite may be disposed on a second substrate (e.g., aluminum foil) to form a cathode. The packet foil insulates the anode-electrolyte layer-cathode assembly from the external environment. The packet foil may be fabricated from polymers, such as polyamide, polyester-polyurethane, polypropylene, and/or metals, such as aluminum. The thickness of the packet foil may range from about 20 μm to about 200 μm. There may be multiple layers of anode, electrolyte layer, and cathode, in a layered cell configuration. The layers may be repeatedly stacked to form multi-layer stackings in a cell configuration, forming anode, electrolyte layer, cathode, electrolyte layer, anode, electrolyte layer, cathode, electrolyte layer . . . and so on, depending on total number of layers.

In some cell embodiments, the cathode contains a cathode material selected from the group consisting of sulfur, sulfurized polyacrylonitrile, ferric fluoride, metal fluoride, metal sulfide, lithium nickel manganese cobalt oxide (LiNiₓCo_{y}Mn_{z}O₂ (x+y+z=1)), lithium nickel manganese oxide (LiMnₓNi_{y}O₂ (x+y=1)), lithium nickel cobalt oxide (LiNiₓCo_{y}O₂ (x+y=1)), lithium nickel cobalt aluminum oxide (LiNiₓCo_{y}Al_{z}O₂ (x+y+z=1)), lithium cobalt oxide (LiCoO₂), lithium nickel manganese spinel oxide ((LiMnₓNi_{y}O₄ (x+y=2))), lithium manganese spinel oxide (LiMn₂O₄), lithium iron phosphate (LiFePO₄), lithium iron manganese phosphate (LiFeₓMn_{y}PO₄ (x+y=1)), Li₂MnO₃, aLiNiₓCo_{y}Mn_{z}O₂·(1-a)Li₂MnO₃ (0<a<1 and x+y+z=1), LiF, Li₂S, Li₂O, Li₂O₂, and combinations thereof. In some embodiments, the cathode material is the LiNiₓCo_{y}Mn_{z}O₂. The LiNiₓCo_{y}Mn_{z}O₂ may be LiNi_{0.8}Co_{0.1}Mn_{0.1}O₂, for example.

In some cell embodiments, the lithium-ion conductor is a liquid lithium-ion conductor. In other cell embodiments, the lithium-ion conductor is a solid lithium-ion conductor.

The cathode layer preferably further contains a cathode carbon additive in sp form, sp² form, and/or sp³ form. The cathode carbon additive may be graphite, graphene, carbon nanotubes, carbon fibers (e.g., vapor-grown carbon fiber), non-graphitized carbon, ultrafine carbon, activated carbon, carbon black, nanodiamonds, hard carbon, soft carbon, or a combination thereof. The cathode carbon additive may be the same type of carbon as the anode carbon additive, or they may be different types of carbon.

In some embodiments, the cathode may have a capacity ranging from about 50 mA·h/g to about 400 mA·h/g, for example. In some embodiments, the active cathode material loading may range from about 50 wt % to about 100 wt %. In some embodiments, the coating weight for each side of the cathode may range from about 0.5 mg/cm² to about 50 mg/cm². In some embodiments, the areal capacity for each side of the cathode may range from about 0.2 mA·h/cm² to about 10 mA·h/cm².

In some embodiments, the cathode press density may range from about 0.3 g/cm³ to about 5 g/cm³. Aluminum foil may be used as a substrate upon which to place the cathode material. In some embodiments, the aluminum foil thickness may range from about 1 μm to about 100 μm. The number of cathode double layers may range from 1 to about 50, for example.

Some embodiments employ a solid electrolyte. The solid electrolyte promotes the movement of ions between the cathode and the anode during charge and discharge. During charging, the lithium ions transport from cathode to anode; while discharging the lithium ions transport from anode to cathode.

In various embodiments, the solid electrolyte is selected from the group consisting of oxides, sulfides, phosphates, argyrodites, β-aluminas, LISICON, garnets, NASICON, perovskites, antiperovskites, lithium nitrides (e.g., lithium metal nitrides), lithium hydrides (e.g., lithium metal hydrides), lithium phosphidotrielates, lithium phosphidotetrelates, lithium halides (e.g., lithium chloride), lithium metal halides (e.g., lithium metal chlorides), UPON, lithium thiophosphates, LiAlH₄, LiBH₄, and combinations thereof. Lithium metal chlorides, Li-M-Cl, may utilize a non-lithium metal M such as, but not limited to, Y, Tb, Lu, Sc, Er, In, or Zr. An exemplary lithium metal chloride is Li₂ZrCl₆. Another exemplary lithium metal chloride is Li₃YCl₃. Generally, in some embodiments, the solid electrolyte may be selected from lithium metal halides Li-M-X, where M=Y, Tb, Lu, Sc, Er, In, or Zr; and X=Cl, Br, I. In this specification, “lithium metal halide” refers to a material that has a metal other than lithium, in addition to lithium.

In some embodiments, solid electrolyte materials can be based on oxides, sulfides, or phosphates, and can have a variety of crystalline structures. Some examples of these structures include LISICON (lithium superionic conductor) (e.g., LGPS, LiSiPS, or LiPS); argyrodite-like structures (e.g. Li₆PS₅X, X=Cl, Br, I); garnets (e.g., LLZO, Li₇La₃Zr₂O₁₂); NASICON (sodium superionic conductor); lithium nitrides (e.g., Li₃N); lithium hydrides (e.g., LiBH₄); lithium phosphidotrielates or phosphidotetrelates; perovskites (e.g., lithium lanthanum titanate, LLTO); and lithium metal halides (e.g., Li₃YCl₆ or Li₃YBr₆). Additionally, some inorganic solid electrolytes can be in an amorphous state, resembling glass ceramics. Examples of these include lithium phosphorus oxynitride (LIPON) and lithium thiophosphates (Li₂S—P₂S₅).

In some embodiments, the solid electrolyte is a sulfur-based superionic conductor, such as a halogen-containing lithium argyrodite. The halogen-containing lithium argyrodite may be selected from Li_{6-ε}PS_{5-ε}X_{1+ε}, wherein −1<ε≤1, and wherein X=F, Cl, Br, I, or a combination thereof. For example, X may be Cl, and 0≤ε≤0.8. In some embodiments, the sulfur-based superionic conductor is selected from the group consisting of Li₂S—P₂S₅, Li₇P₃S₁₁, Li₁₀GeP₂S₁₂, Li₇SiPS₈, Li₃PS₄, Li₁₊₂ₓZn₁₋ₓPS₄ (0≤x<1), and combinations thereof.

In some embodiments, the solid electrolyte is an oxide-based superionic conductor. The oxide-based superionic conductor may be selected from the group consisting of Li—Al₂O₃, Li₇La₃Zr₂O₁₂, Li₂₊₂ₓZn₁₋ₓGeO₄ (0≤x≤1), Li₁₊ₓZr₂SiₓP₃₋ₓO₁₂ (0<x<3), La_{2/3-x}Li₃ₓTiO₃ (0<x<⅔), LiₓX¹₃X²₂O₁₂ (X¹=La, Nd, Mg, or Ba; X²=Te, Ta, Nb, Zr, or In; and 0<x<7), and combinations thereof.

In some embodiments, the solid electrolyte is a phosphate-based superionic conductor. The phosphate-based superionic conductor may be selected from the group consisting of Li₃PO₄, Li₁₊ₓX¹ₓX²₂₋ₓ(PO₄)₃(X¹=Al, La, In, or Cr; X²=Ti, Ge, Zr, Hf, or Sn; and 0<x<2), and combinations thereof.

In some embodiments, the solid electrolyte is a nitride-based superionic conductor. The nitride-based superionic conductor may be selected from the group consisting of Li₃N, LiₓPO_{y}N_{z} (0<x≤3; 0<y≤4; and 0<z≤1), and combinations thereof.

In some embodiments, the solid electrolyte is a hydride-based superionic conductor. The hydride-based superionic conductor may be selected from the group consisting of LiBH₄, LiCB₉H₁₀, LiCB₁₁H₁₂, and combinations thereof.

In some embodiments, in which the solid electrolyte is selected from antiperovskites, the antiperovskites are selected from the group consisting of Li₃OCl, Li₃OBr, Li₃OF, Li₃OI, and combinations thereof.

In some embodiments, the solid electrolyte layer contains a mixed electrolyte, i.e., a mixture of two or more different types of solid electrolyte. In some embodiments, the solid electrolyte layer contains or consists of a few different layers with different solid electrolyte materials.

In some solid-state lithium-ion batteries, the solid electrolyte is also contained within the anode layer. In these or other embodiments, the solid electrolyte is also contained within the cathode layer. The anode layer and the cathode layer may incorporate different solid electrolytes.

In certain embodiments, the anode layer, the cathode layer, or the solid electrolyte layer further contains a noble metal in neutral or ionic form. The noble metal is typically present only in trace concentrations. The noble metal may be selected from the group consisting of Au, Ag, Pt, Rh, Pd, Ru, Os, Ir, and combinations thereof.

Typically, the cathode layer is disposed on a cathode current collector (e.g., Al foil), and the anode layer is disposed on an anode current collector (e.g., Cu foil). In some embodiments, the lithium-ion battery contains a plurality of anode layers, a plurality of solid electrolyte layers, and a plurality of cathode layers.

In some cell embodiments, the cell is capable of charging from 0% state of charge to 80% state of charge in about 15 minutes or less when charged at a rate of 5C and at a temperature of 25° C.

In some cell embodiments, the cell is capable of charging from 0% state of charge to 80% state of charge in about 10 minutes or less when charged at a rate of 10C and at a temperature of 25° C.

In some cell embodiments, the cell is capable of charging from 0% state of charge to 80% state of charge in about 5 minutes or less when charged at a rate of 15C and at a temperature of 25° C.

In some cell embodiments, the cell is capable of charging from 0% state of charge to 80% state of charge in about 5 minutes or less when charged at a rate of 20C and at a temperature of 25° C.

In some cell embodiments, the anode delivers at least 500 mA·h/g at a temperature of 25° C. when discharged at a rate of C/3. In certain cell embodiments, the anode delivers at least 600 mA·h/g at a temperature of 25° C. when discharged at a rate of C/3.

In some cell embodiments, the anode delivers at least 400 mA·h/g at a temperature of −20° C. when discharged at a rate of C/3. In certain cell embodiments, the anode delivers at least 500 mA·h/g at a temperature of −20° C. when discharged at a rate of C/3.

In some cell embodiments, the cell is characterized by a capacity loss of less than 0.8% per degree Celsius over the temperature range from 25° C. to −20° C. In certain cell embodiments, the cell is characterized by a capacity loss of less than 0.4% per degree Celsius over the temperature range from 25° C. to −20° C.

The cell may be contained in a module or pack. A module or pack generally contains a plurality of cells.

The cell may be contained in an electric device, such as a portable computer or a power tool.

The cell may be contained in an electric vehicle, such as (but not limited to) an electric vehicle selected from electric cars, electric trucks, electric motorcycles, electric buses, electric utility vehicles, electric airplanes, or electric locomotives.

In some embodiments, the lithium-ion battery is contained within a portable device. In some embodiments, the lithium-ion battery is contained within a smart device. In some embodiments, the lithium-ion battery is contained within an emergency power backup system. In some embodiments, the lithium-ion battery is contained within an energy storage system. In some embodiments, the lithium-ion battery is contained within a solar-power electricity storage system.

The battery charge/discharge current may be expressed as a C-rate in order to normalize against battery capacity. A C-rate is a measure of the rate at which a battery is charged/discharged relative to its maximum capacity. A 1C rate means that the charge/discharge current will charge/discharge the battery in 1 hour. For a battery with a capacity of 10 A·h (amp-hours), this equates to a charge/discharge current of 10 A (amps). A 20C rate for this battery would be 200 A, and a C/2 rate would be 5 A.

In typical methods of use, a cell is repeatedly charged and discharged over multiple charge-discharge cycles, wherein the anode is reversibly lithiated and delithiated a plurality of times. The cell may be charged and discharged over at least 1000 cycles, for example. In various embodiments, the number of charge-discharge cycles is 1, 2, 3, 4, 5, 10, 20, 30, 40, 50, 60, 70, 80, 90, 100, 200, 300, 400, 500, 600, 700, 800, 900, 1000, 1100, 1200, 1500, 2000, 2500, 3000, 3500, 4000, 4500, or 5000, or even more, for example.

The battery system may be rechargeable in about, or less than about, 30, 25, 20, 15, 10, 9, 8, 7, 6, 5, 4, 3, 2, 1, 0.5, 0.2, or 0.1 minutes, in various embodiments.

In some embodiments, the presently disclosed technology may be used in a battery system that is superior to conventional graphite battery packs and which has a lower number of cells in the battery pack. The battery system is suitable for many commercial applications, including electric vehicles, smart devices, and high-power portable devices with high energy density.

One skilled in the battery art will appreciate that the principles of battery design, including calculations, modeling, simulations, and engineering may be carried out using the benefit of the present disclosure and the anode materials. One skilled in the battery art, with the benefit of this disclosure, will understand how to scale a battery cell larger or smaller for different battery applications.

In some embodiments of the invention, one or more individual components of a lithium-ion battery are produced and then sent to another party for incorporating into a cell. In some embodiments of the invention, a cell is produced and then sent to another party for incorporating into a final device or vehicle. In some embodiments of the invention, a cell is produced and then sent to another party for incorporating into a module. In some embodiments of the invention, a module is produced and then sent to another party for incorporating into a final device or vehicle. In some embodiments of the invention, a cell is produced and then sent to another party for incorporating into a pack. In some embodiments of the invention, a module is produced and then sent to another party for incorporating into a pack. In some embodiments of the invention, a pack is produced and then sent to another party for incorporating into a final device or vehicle.

### EXAMPLES

### Example 1: Testing of LVO-SiO Anode Material in Coin Cell

SiO (silicon monoxide) material was incorporated into the LVO electrode (LVO-SiO) to enhance capacity. In this example, the concentration of the SiO was 20 wt %, while the concentration of the LVO was 80 wt %, within the anode material on a carbon-free and binder-free basis. The SiO and LVO were physically mixed together, as a blend of particles.

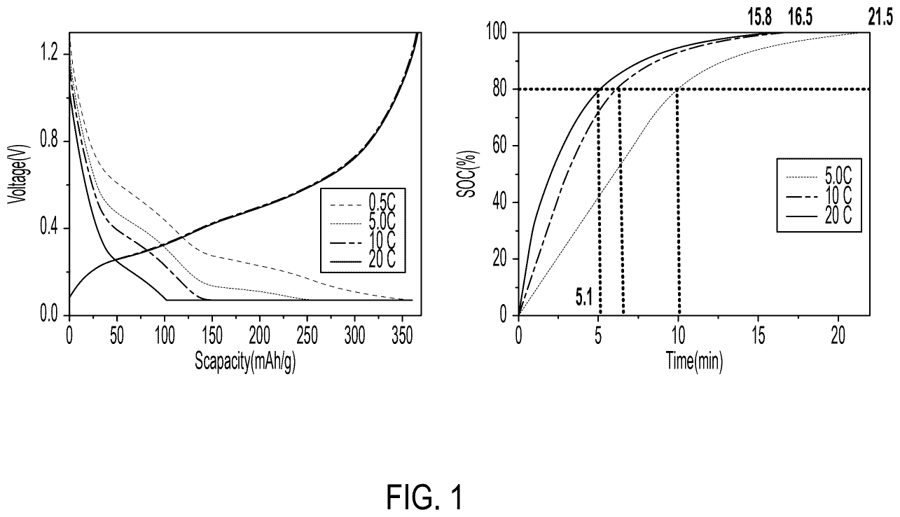

The charging capabilities of these modified electrodes were evaluated in coin cells with Li metal as the counter electrode across various C-rates. Both voltage profiles and SOC vs. lithiation time plots are presented in FIG. 1.

FIG. 1, left graph shows the voltage profile of Tyfast LVO-SiO anode under 0.5C, 5C, 10C, and 20C constant current lithiation with constant voltage step current cut at 0.33C and 0.33C delithiation in the coin cell with Li counter electrode. The voltage window is 0.07-1.30 V. FIG. 1, right graph demonstrates 5.1 min charge time from 0 to 80% SOC for a 20C rate.

Initially, the LVO-SiO electrode achieved a high capacity of approximately 360 mA·h/g. The cell showed notable fast-charging capabilities, achieving 0 to 80% state of charge (SOC) in 10 minutes at a 5C rate, 6.2 minutes at 10C, and a rapid 5.1 minutes at a 20C rate.

### Example 2: Testing of LVO-Si/C Anode Material in Coin Cell

Si/C (silicon-carbon composite) material was incorporated into the LVO electrode (LVO-Si/C) to enhance capacity. The concentration of the Si/C was 20 wt %, while the concentration of the LVO was 80 wt %, in this example. The Si/C and LVO were physically mixed together, as a blend of particles.

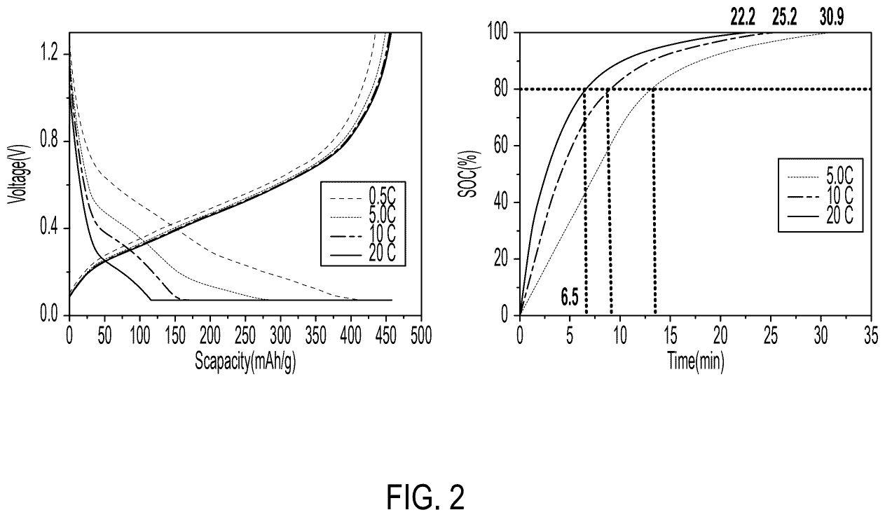

The charging capabilities of these modified electrodes were evaluated in coin cells with Li metal as the counter electrode across various C-rates. Both voltage profiles and SOC vs. lithiation time plots are presented in FIG. 2.

FIG. 2, left graph shows the voltage profile of Tyfast LVO-Si/C anode under 0.5C, 5C, 10C, and 20C constant current lithiation with constant voltage step current cut at 0.33C and 0.33C delithiation in the coin cell with Li counter electrode. The voltage window is 0.07-1.30 V. FIG. 2, right graph demonstrates 6.5 min charge time from 0 to 80% SOC at a 20C rate.

Initially, the LVO-Si/C electrode achieved a high capacity of approximately 460 mA·h/g. The cell showed notable fast-charging capabilities, achieving 0 to 80% SOC in 13.1 minutes at a 5C rate, in 8.9 minutes at a 10C rate, and in 6.5 minutes (rapid) at a 20C rate.

### Example 3: Cycling Stability of LVO-Si/C and LVO-SiO Anode Materials

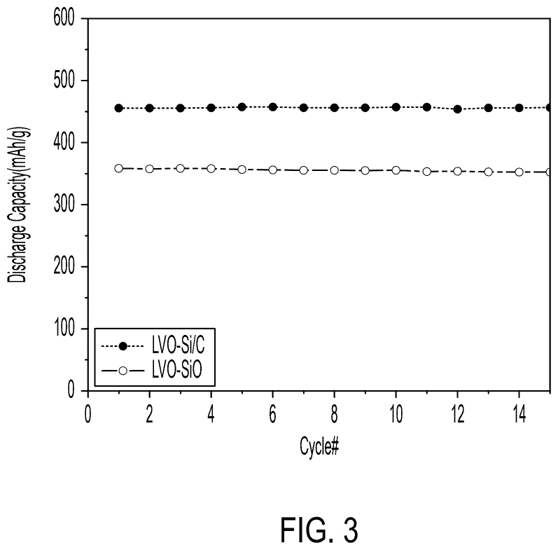

The cycling stability of both the LVO-SiO and LVO-Si/C anode materials, from Examples 1 and 2, respectively, were evaluated in coin cells with Li metal as the counter electrode as presented in FIG. 3.

FIG. 3 shows the cycling performance of Tyfast LVO-Si/C and LVO-SiO anode under 15C constant current lithiation with constant voltage step current cut at 0.33C and 0.33C delithiation in the coin cell with Li counter electrode. The voltage window is 0.07-1.30 V.

The cell was lithiated at a 15C rate with a constant-voltage step cut-off at C/3 and delithiated at C/3 between 2-4.0 V. Initial cycling has shown that both materials are stable.

### Example 4: Testing of LVO-SiO Anode Material in Pouch Cell

The SiO material was incorporated into the LVO electrode (LVO-SiO) to enhance capacity. The concentration of the SiO was 20 wt %, while the concentration of the LVO was 80 wt %, in this example. The SiO and LVO were physically mixed together, as a blend of particles.

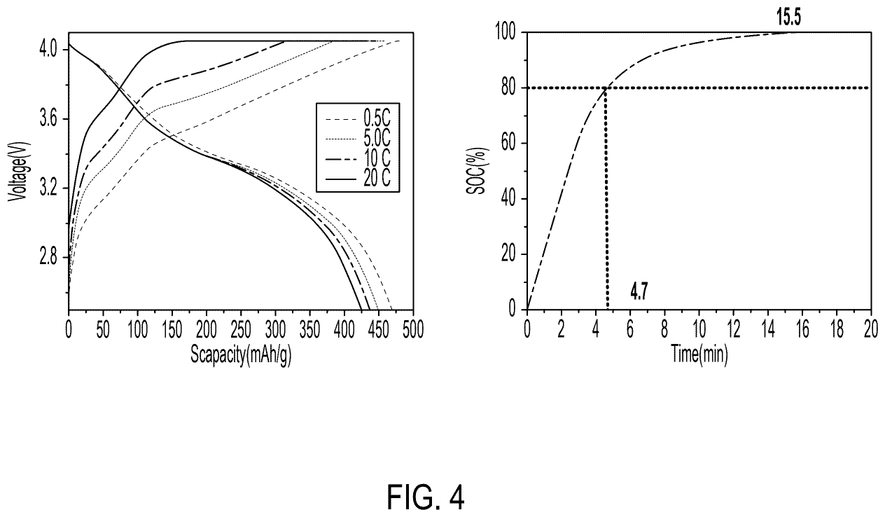

The charging capabilities of these modified electrodes were evaluated in pouch cells with NMC811 cathode as the counter electrode across various C-rates. Voltage profiles and SOC vs. lithiation time plots are presented in FIG. 4.

FIG. 4, left graph shows the voltage profile of Tyfast LVO-SiO∥NMC811 full pouch cell under 0.5C, 5C, 10C, and 20C constant current charge with constant voltage step current cut at 0.33C and 0.33C discharge. The voltage window is 2.5-4.05 V. FIG. 4, right graph demonstrates 4.7 min charge time from 0 to 80% SOC. The cell showed notable fast-charging capabilities, achieving 0-80% SOC in a rapid 4.7 minutes at a 15C rate.

### Example 5: Cycling Stability of LVO-SiO Anode Material in Pouch Cell

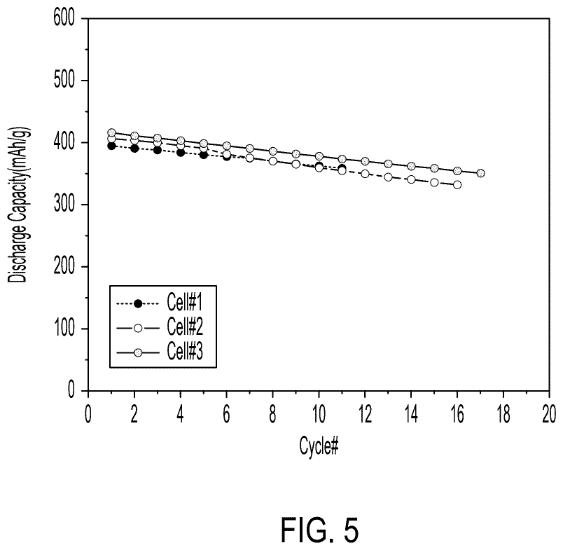

The cycling stability of the LVO-SiO material from Example 4 was evaluated in pouch cells with NMC811 cathode as the counter electrode as presented in FIG. 5. The cell was charged at a 15C rate with a CV step cut-off at C/3 and discharged at C/3 between 2-4.05 V.

FIG. 5 shows the cycling performance of Tyfast LVO-SiO∥NMC811 full pouch cell under 15C constant current charge with constant voltage step current cut at 0.33C and 0.33C discharge. The voltage window is 2.5-4.05 V.

### Example 6: Testing of LVO-Si/C Anode Material in Pouch Cell

Si/C (silicon-carbon composite) material was incorporated into the LVO electrode (LVO-Si/C) to enhance capacity. The concentration of the Si/C was 20 wt %, while the concentration of the LVO was 80 wt %, in this example. The Si/C and LVO were physically mixed together, as a blend of particles.

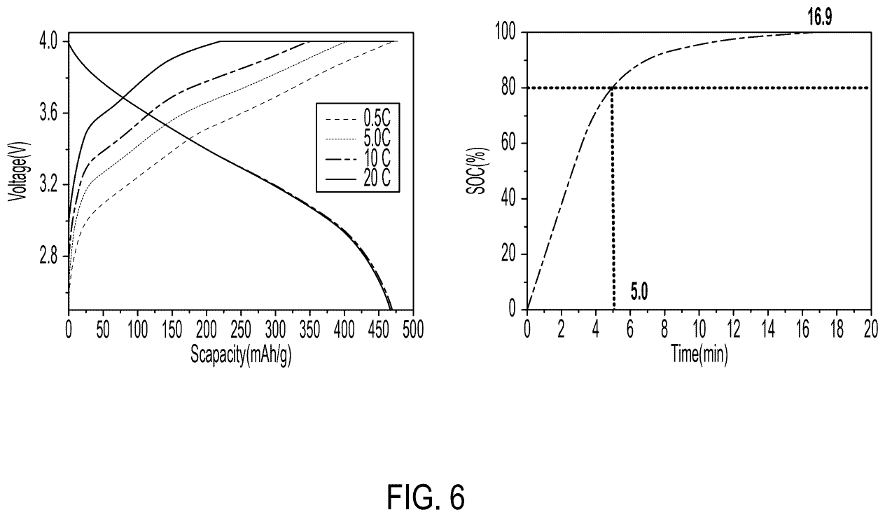

The charging capabilities of these modified electrodes were evaluated in pouch cells with NMC811 cathode as the counter electrode across various C-rates. Both voltage profiles and SOC vs. lithiation time plots are presented in FIG. 6.

FIG. 6, left graph shows the voltage profile of Tyfast LVO-Si/C∥NMC811 full pouch cell under 0.5C, 5C, 10C, and 20C constant current charge with constant voltage step current cut at 0.33C and 0.33C discharge. The voltage window is 2.5-4.0 V. FIG. 6, right graph demonstrates 5.0 min charge time from 0 to 80% SOC. The cell showed notable fast-charging capabilities, achieving 80% SOC (starting from SOC=0) in a rapid 5.0 minutes at a 15C rate.

### Example 7: Cycling Stability of LVO-Si/C Anode Material in Pouch Cell

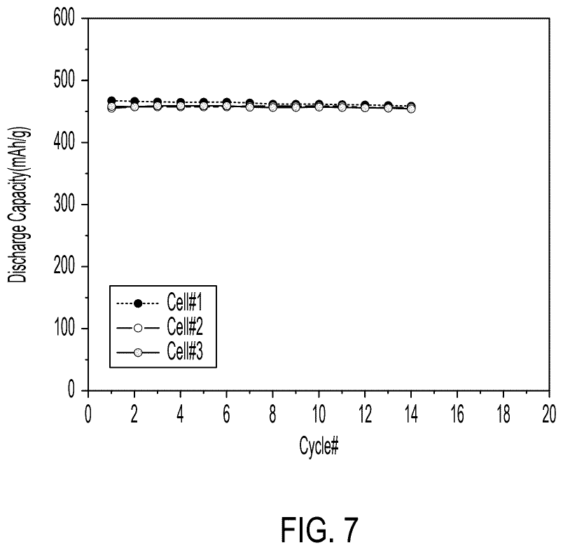

The cycling stability of the LVO-Si/C material from Example 6 was evaluated in pouch cells with NMC811 cathode as the counter electrode as presented in FIG. 7.

FIG. 7 shows the cycling performance of Tyfast LVO-Si/CIINMC811 full pouch cell under 15C constant current charge with constant voltage step current cut at 0.33C and 0.33C discharge. The voltage window is 2.5-4.0 V.

The cell was charged at a 15C rate with a CV step cut-off at C/3 and discharged at C/3 between 2-4.05 V. The full cell maintains stable capacity, indicating the stability of the LVO-Si/C∥NMC811 full cell system.

### Example 8: Temperature Stability of LVO-Si/C Anode Material

Cell discharging is performed at room temperature (about 25° C.) as well as at a low temperature of −20° C., using the LVO-Si/C material from Example 6.

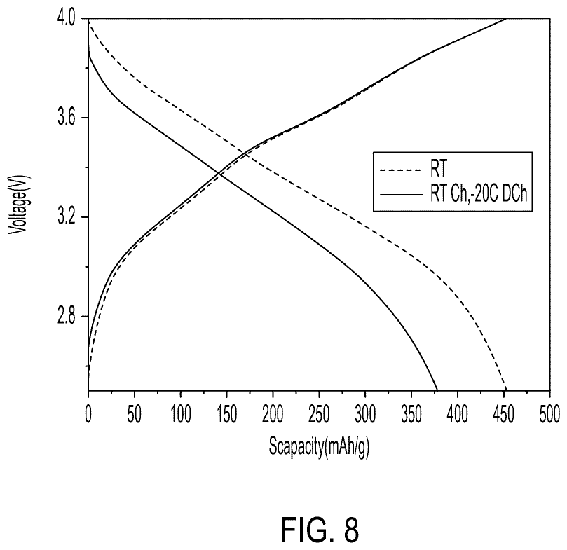

The voltage profiles are presented in FIG. 8. FIG. 8 shows the voltage profiles of Tyfast LVO-Si/C∥NMC811 full pouch cell under 0.5C constant current charge with constant voltage step current cut at 0.33C charge and 0.33C discharge, at a temperature of 25° C. (room temperature, “RT”) and −20° C.

Initially, the capacity was calculated based on the LVO-Si/C electrode. The cell demonstrated remarkable fast-charging capabilities, even at 20C. When discharged at both room temperature and at −20° C. at a rate of C/3, the anode of the cell delivered 452 mA·h/g at room temperature and 376 mA·h/g at −20° C. The total discharge capacity drop was only 16.5% at −20° C., compared to 25° C., which is remarkable. This results in a capacity loss of only 0.37% per ° C., demonstrating excellent performance at low temperatures.

### Example 9: Testing of LVO-Si/C Anode Material in Coin Cell

Si/C (silicon-carbon composite) material was incorporated into a LVO electrode (LVO-Si/C) to enhance capacity. The concentration of the Si/C was 35 wt %, while the concentration of the LVO was 65 wt %, in this example. The Si/C and LVO were physically mixed together, as a blend of particles.

Initially, the LVO-Si/C electrode achieved a high capacity of approximately 624 mA·h/g. The high electrode capacity is believed to be due to the optimized concentrations of LVO and Si/C within the LVO-Si/C anode material.

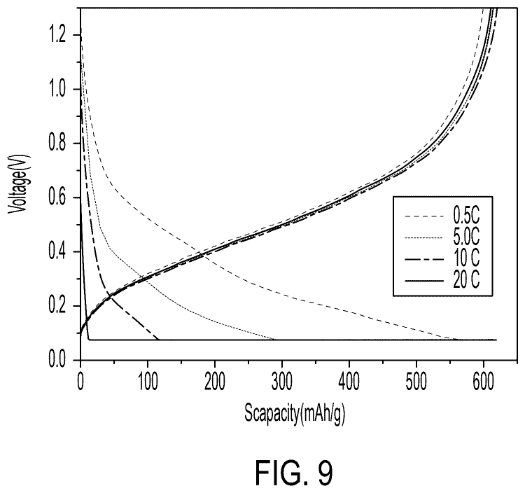

The charging capabilities of these electrodes were evaluated in coin cells with Li metal as the counter electrode across various C-rates. FIG. 9 shows the voltage profile of Tyfast LVO-Si/C anode under 0.5C, 5C, 10C, and 20C constant current lithiation with constant voltage step current cut at 0.33C and 0.33C delithiation in the coin cell with Li counter electrode. The voltage window is 0.07-1.30 V. The cell showed notable fast-charging capabilities.

### Example 10: Cycling Stability of LVO-Si/C Anode Material in Pouch Cell

The cycling stability of the LVO-Si/C composite of Example 9 (containing 35 wt % Si/C and 65 wt % LVO, physically blended as a mixture of particles) was evaluated in pouch cells using an NMC811 cathode as the counter electrode.

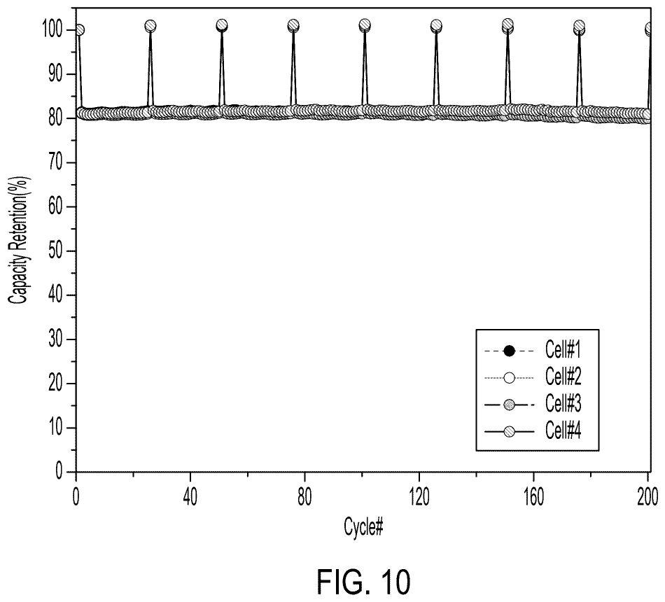

FIG. 10 shows the cycling performance of the Tyfast LVO-Si/C∥NMC811 full pouch cell. The protocol consisted of three cycles at 3C constant current charge with constant voltage step current cut at 0.33C, followed by one cycle at 1° C. constant current charge with constant voltage step current cut at 0.33C and C/3 discharge, using an 80% SOC swing. In addition, after every 24 cycles, one cycle was performed with a 100% SOC swing at 3C constant current charge with constant voltage step current cut at 0.33C. The overall voltage window was 2.5-4.1 V. As shown in FIG. 10, four full pouch cells paired with NMC811 cathodes were cycled at room temperature (about 25° C.), and all cells retained nearly 100% of their initial capacity after 200 cycles. The full cell maintains stable capacity, indicating the remarkable stability of the LVO-Si/C∥NMC811 full cell system.

In this detailed description, reference has been made to multiple embodiments and to the accompanying drawings in which are shown by way of illustration specific exemplary embodiments of the technology. These embodiments are described in sufficient detail to enable those skilled in the art to practice the technology, and it is to be understood that modifications to the various disclosed embodiments may be made by a skilled artisan.

Where methods and steps described above indicate certain events occurring in certain order, those of ordinary skill in the art will recognize that the ordering of certain steps may be modified and that such modifications are in accordance with the variations of the technology. Additionally, certain steps may be performed concurrently in a parallel process when possible, as well as performed sequentially.

All publications, patents, and patent applications cited in this specification are herein incorporated by reference in their entirety as if each publication, patent, or patent application were specifically and individually put forth herein.

This disclosure hereby incorporates by reference U.S. Patent App. Pub. No. 2021/0184210 A1, published on Jun. 17, 2021. This disclosure also hereby incorporates by reference U.S. Patent App. Pub. No. 2023/0120748 A1, published on Apr. 20, 2023. This disclosure also hereby incorporates by reference U.S. Patent App. Pub. No. 2024/0113282 A1, published on Apr. 4, 2024.

The embodiments, variations, and figures described above should provide an indication of the utility and versatility of the present technology. Other embodiments that do not provide all of the features and advantages set forth herein may also be utilized, without departing from the spirit and scope of the technology. Such modifications and variations are considered to be within the scope of the technology defined by the claims.

While various embodiments of the disclosed technology have been described above, it should be understood that they have been presented by way of example only, and not of limitation. Likewise, the various diagrams may depict an example architectural or other configuration for the disclosed technology, which is done to aid in understanding the features and functionality that can be included in the disclosed technology. The disclosed technology is not restricted to the illustrated example architectures or configurations, but the desired features can be implemented using a variety of alternative architectures and configurations. It will be apparent to one of skill in the art how alternative functional, logical, or physical partitioning and configurations can be implemented to implement the desired features of the technology disclosed herein. Additionally, with regard to flow diagrams, operational descriptions, and methods, the order in which the steps are presented herein shall not mandate that various embodiments be implemented to perform the recited functionality in the same order unless the context dictates otherwise.

Although the disclosed technology is described above in terms of various exemplary embodiments and implementations, it should be understood that the various features, aspects, and functionality described in one or more of the individual embodiments are not limited in their applicability to the particular embodiment with which they are described, but instead can be applied, alone or in various combinations, to one or more of the other embodiments of the disclosed technology, whether or not such features are presented as being a part of a described embodiment. Thus, the breadth and scope of the technology disclosed herein should not be limited by any of the above-described exemplary embodiments. As will become apparent to one of ordinary skill in the art after reading this patent application, the illustrated embodiments and their various alternatives can be implemented without confinement to the illustrated examples.

What is claimed is:

1. An anode material comprising:
(a) a Si/C composite containing silicon (Si) and carbon (C), wherein said Si/C composite is present in the form of first particles;
(b) lithium vanadium oxide (LVO) with a composition given by LiₐV_{b}O_{c}, wherein a=0.1-10, b=1-3, c=1-9, and a, b, and c are selected to charge-balance said LiₐV_{b}O_{c}, wherein said LiₐV_{b}O_{c} is capable of being reversibly lithiated, and wherein said LVO is present in the form of second particles,
wherein said first particles and said second particles are physically mixed together,
wherein said Si/C composite is present in a Si/C concentration from about 1 wt % to about 99 wt % in said anode material, and
wherein said LVO is present in a LVO concentration from about 1 wt % to about 99 wt % in said anode material.

2. The anode material of claim 1, wherein said anode material is a lithium-ion-battery anode material.

3. The anode material of claim 1, wherein at least some of said LiₐV_{b}O_{c} has a disordered rocksalt structure in the Fm3̅m space group, and optionally wherein a>3 in said LiₐV_{b}O_{c}.

4. The anode material of claim 1, wherein said Si/C concentration is from about 10 wt % to about 50 wt %.

5. The anode material of claim 1, wherein said LVO concentration is from about 50 wt % to about 90 wt %.

6. The anode material of claim 1, wherein said Si/C composite contains from about 20 wt % to about 60 wt % of said carbon, and from about 40 wt % to about 80 wt % of said silicon.

7. The anode material of claim 1, wherein said lithium vanadium oxide further contains a dopant M that is chemically or physically contained within the lithium vanadium oxide.

8. The anode material of claim 1, wherein said dopant M is selected from the group consisting of Na, K, Be, Mg, Ca, Zn, Fe, Co, Ni, Cu, Ag, Sc, B, Y, Al, La, Si, Ge, Sn, Ti, Zr, Mn, P, Nb, Ta, Cr, Mo, W, Se, N, S, F, Cl, Br, I, and combinations thereof.

9. A cell containing an anode, a cathode, and a lithium-ion conductor interposed between said anode and said cathode, and wherein said anode contains said anode material comprising:
(a) a Si/C composite containing silicon (Si) and carbon (C), wherein said Si/C composite is present in the form of first particles;
(b) lithium vanadium oxide (LVO) with a composition given by LiₐV_{b}O_{c}, wherein a=0.1-10, b=1-3, c=1-9, and a, b, and c are selected to charge-balance said LiₐV_{b}O_{c}, wherein said LiₐV_{b}O_{c} is capable of being reversibly lithiated, and wherein said LVO is present in the form of second particles,
wherein said first particles and said second particles are physically mixed together,
wherein said Si/C composite is present in a Si/C concentration from about 1 wt % to about 99 wt % in said anode material, and
wherein said LVO is present in a LVO concentration from about 1 wt % to about 99 wt % in said anode material.

10. The cell of claim 9, wherein said cathode contains a cathode material selected from the group consisting of sulfur, sulfurized polyacrylonitrile, ferric fluoride, metal fluoride, metal sulfide, lithium nickel manganese cobalt oxide (LiNiₓCo_{y}Mn_{z}O₂ (x+y+z=1)), lithium nickel manganese oxide (LiMnₓNi_{y}O₂ (x+y=1)), lithium nickel cobalt oxide (LiNiₓCo_{y}O₂ (x+y=1)), lithium nickel cobalt aluminum oxide (LiNiₓCo_{y}Al_{z}O₂ (x+y+z=1)), lithium cobalt oxide (LiCoO₂), lithium nickel manganese spinel oxide ((LiMnₓNi_{y}O₄ (x+y=2))), lithium manganese spinel oxide (LiMn₂O₄), lithium iron phosphate (LiFePO₄), lithium iron manganese phosphate (LiFeₓMn_{y}PO₄ (x+y=1)), Li₂MnO₃, aLiNiₓCo_{y}Mn_{z}O₂·(1-a)Li₂MnO₃ (0<a<1 and x+y+z=1), LiF, Li₂S, Li₂O, Li₂O₂, and combinations thereof.

11. The cell of claim 9, wherein said lithium-ion conductor is a liquid lithium-ion conductor.

12. The cell of claim 9, wherein said lithium-ion conductor is a solid lithium-ion conductor.

13. The cell of claim 9, wherein said lithium-ion conductor is a polymer gel lithium-ion conductor.

14. The cell of claim 9, wherein said anode delivers at least 500 mA·h/g at a temperature of 25° C. when discharged at a rate of C/3.

15. The cell of claim 9, wherein said anode of cell delivers at least 400 mA·h/g at a temperature of −20° C. when discharged at a rate of C/3.

16. The cell of claim 9, wherein said cell is characterized by a capacity loss of less than 0.8% per degree Celsius over the temperature range from 25° C. to −20° C.

17. The cell of claim 9, wherein said cell is contained in a module or pack.

18. The cell of claim 9, wherein said cell is contained in an electric device.

19. The cell of claim 9, wherein said cell is contained in an electric vehicle.

20. The cell of claim 19, wherein said electric vehicle is selected from the group consisting of electric cars, electric trucks, electric motorcycles, electric buses, electric utility vehicles, electric airplanes, and electric locomotives.

21. An anode material comprising:
(a) silicon monoxide (SiO), wherein said SiO is present in the form of first particles; and
(b) lithium vanadium oxide (LVO) with a composition given by LiₐV_{b}O_{c}, wherein a=0.1-10, b=1-3, c=1-9, and a, b, and c are selected to charge-balance said LiₐV_{b}O_{c}, wherein said LiₐV_{b}O_{c} is capable of being reversibly lithiated, and wherein said LVO is present in the form of second particles,
wherein said first particles and said second particles are physically mixed together.
